(19) United States
(12) Patent Application Publication
(10) Pub. No.: US 2023/0145434 A1
(43) Pub. Date: May 11, 2023

(54) FUEL ECONOMIZER

(71) Applicant: Kun-Lin TSAI, Tainan City (TW)

(72) Inventor: Liang-Shi CHEN, Tainan City (TW)

(21) Appl. No.: 17/523,928

(22) Filed: Nov. 11, 2021

(51) Int. Cl. F02M 1/16; F02M 53/02; F02M 27/00

(52) U.S. Cl. CPC F02M 1/16; F02M 53/02; F02M 27/00

(57) ABSTRACT

The fuel economizer is series-connected between a fuel tank and a fuel vaporization device of an internal combustion engine, and includes a first piping element and an oil cup. A first end of the first piping element is connected to the fuel vaporization device, and a second end of the first piping element is connected to the fuel tank through the oil cup for filtering the fuel tank's fuel. A spirally threaded shaft is tightly housed inside the first piping element and the spirally threaded shaft's outer circumference is configured with spiral threads to speed, rotate, and disturb the fuel as the fuel flows through to disrupt the surface tension and density of the fuel.

### BACKGROUND OF THE INVENTION

### (a) Technical Field of the Invention

The present invention is generally related to the reduction of energy consumption, and more particular to an engine fuel economizer.

### (b) Description of the Prior Art

As shown in FIG. 1, an installation environment for an ordinary fuel economizer includes a fuel tank 20 and a carburetor 30 interconnected by a fuel pipe 50. The fuel 40 stored in the fuel tank 20 flows into an internal combustion engine 10 through the fuel pipe 50 and carburetor 30. The fuel pipe 50 is only for delivering the fuel 40 and has no other function.

To install a fuel economizer for the internal combustion engine 10, it is usually configured outside the internal combustion engine 10 along with some other pipe (both fuel economizer and the other pipe are not shown). It is clear that the installation of fuel economizer requires additional piping while the fuel pipe 50 is under-utilized.

### SUMMARY OF THE INVENTION

To obviate the above shortcoming, the present invention teaches a novel fuel economizer integrally integrated with the fuel pipe.

The fuel economizer is series-connected between a fuel tank and a fuel vaporization device of an internal combustion engine, and includes a first piping element and an oil cup. A first end of the first piping element is connected to the fuel vaporization device, and a second end of the first piping element is connected to the fuel tank through the oil cup for filtering the fuel tank's fuel. A spirally threaded shaft is tightly housed inside the first piping element and the spirally threaded shaft's outer circumference is configured with spiral threads to speed, rotate, and disturb the fuel as the fuel flows through to disrupt the surface tension and density of the fuel.

The oil cup includes a second piping element, a third piping element, and a filter. Both ends of the third piping element respectively connects the second piping element and the fuel tank. The second piping element has a filter chamber inside for housing the filter for filtering the fuel as it flows through. A first threaded section is configured along an inner wall of the filter chamber around a front end of the filter chamber, and a second threaded section is configured around a circumference of a back end of the third piping element. The second threaded section is detachably coupled to the first threaded section, thereby limiting the filter.

The spiral threads includes at least three threads for speeding, rotating, disrupting, and reducing surface tension and density of the fuel. The spirally threaded shaft has cone-shaped first and second tips respectively at both ends of the spirally threaded shaft.

The advantages of the present invention lie in that the spiral threads around the spirally threaded shaft speed, rotate, and disrupt the fuel as the fuel flows through to reduce the fuel's surface tension and density. There is no need to have separate piping for the fuel economizer. The spirally threaded shaft's cone-shaped tips enhance the smoothness when the fuel flows through.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a common installation environment for fuel economizer.

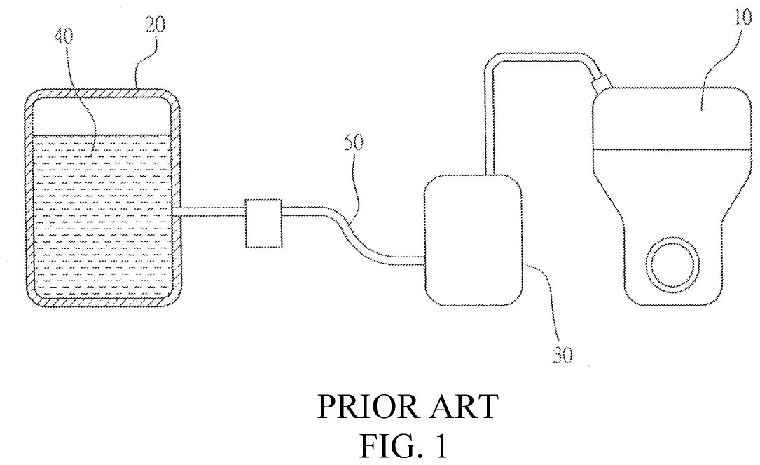

FIG. 2 is a sectional diagram showing a fuel economizer according to an embodiment of the present invention within an installation environment.

FIG. 3 is a perspective breakdown diagram showing the fuel economizer of FIG. 2.

FIG. 4 is a sectional diagram showing the fuel economizer of FIG. 2.

FIG. 5 is a cross-sectional diagram showing a spirally threaded shaft of the fuel economizer of FIG. 2.

FIG. 6 depicts a working scenario of the spirally threaded shaft of FIG. 5.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

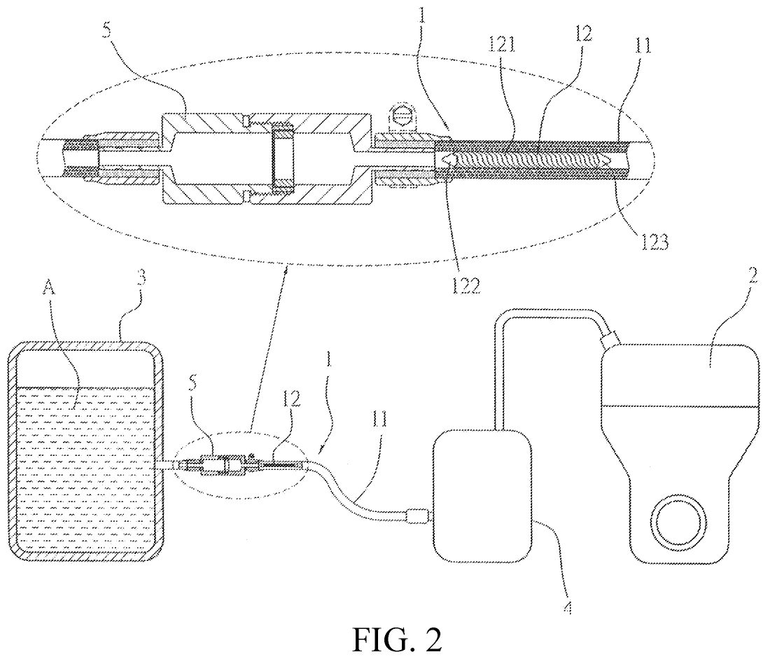

As shown in FIGS. 2 to 6, a fuel economizer 1 according to an embodiment of the present invention is installed between a fuel tank 3 and a fuel vaporization device 4. Fuel A stored in the fuel tank 3 flows through the fuel economizer 1 into the fuel vaporization device 4, where fuel A is vaporized and fed into an internal combustion engine 2. The fuel economizer 1 includes a first piping element 11, and an oil cup 5 connected to an end of first piping element 11 for the filtration of the fuel A. The first piping element 11 is connected to the fuel tank 3 through the oil cup 5. The other end of the first piping element 11 is connected to the fuel vaporization device 4. Inside the first piping element 11, at least a spirally threaded shaft 12 is tightly housed. The spirally threaded shaft 12's outer circumference is configured with spiral threads 121 to rotate and disturb the fuel A as the fuel A flows through so as to disrupt the surface tension and density of the fuel A. As shown in FIG. 2, the internal combustion engine 2 may be a turbojet engine for a vehicle, and the internal combustion engine 2 may be applied to automobiles, motorcycles, aerial vehicles, or marine vehicles. The first piping element 11 may be a fuel pipe.

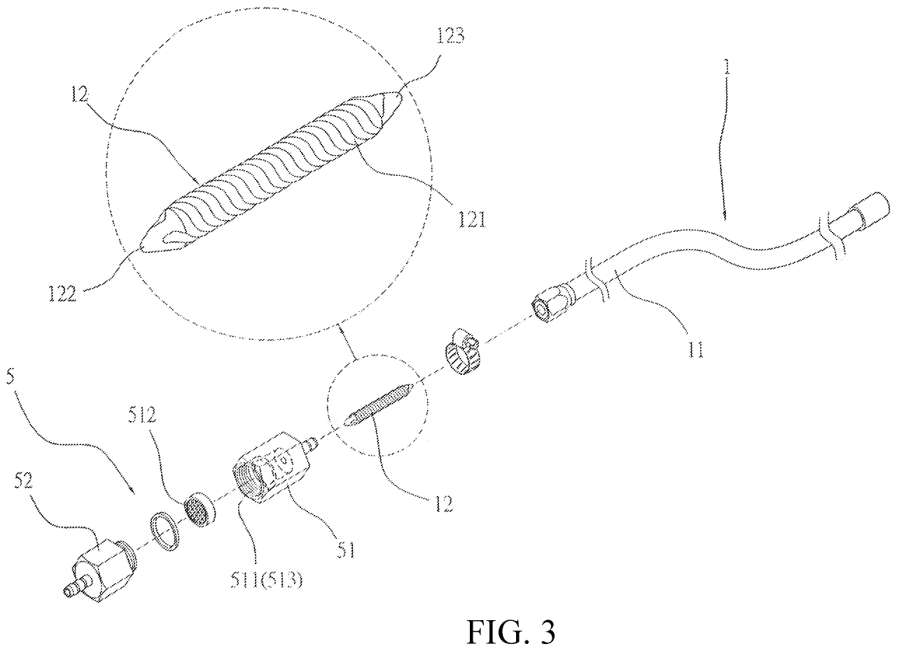

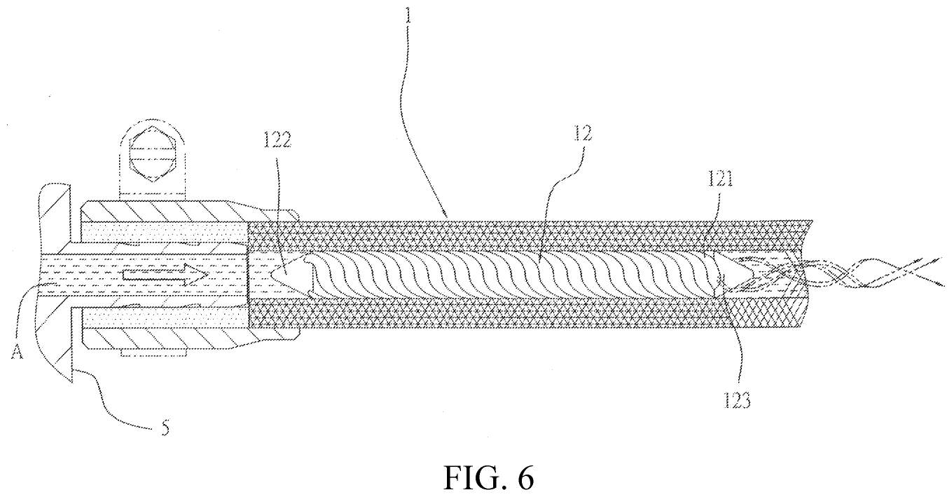

Preferably, the first piping element 11 is a flexible tube made with a stainless steel mesh so that the first piping element 11 has an enhanced strength and prolonged operation life, and is prevented from rupture under the pressure of the fuel A. The oil cup 5 includes a second piping element 51 and a third piping element 52 series-connected between the first piping element 11 and the fuel tank 3. The second piping element 51 has a filter chamber 511 inside for housing a filter 512 for filtering the fuel A as it flows through. A first threaded section 513 is configured along an inner wall of the filter chamber 511 around a front end of the filter chamber 511. A second threaded section 521 is configured around the circumference of a back end of the third piping element 52. The second threaded section 521 is coupled to the first threaded section 513, thereby limiting the filter 512. The detachable coupling between the second piping element 51 and the third piping element 52 provides convenient replacement to the filter 512. The filtration of the fuel A by the filter 512 would allow the fuel A to flow through the spirally threaded shaft 12 with a greater speed under reduced resistance, in addition to enhancing the safety of the internal combustion engine 2, as shown in FIGS. 3 and 6.

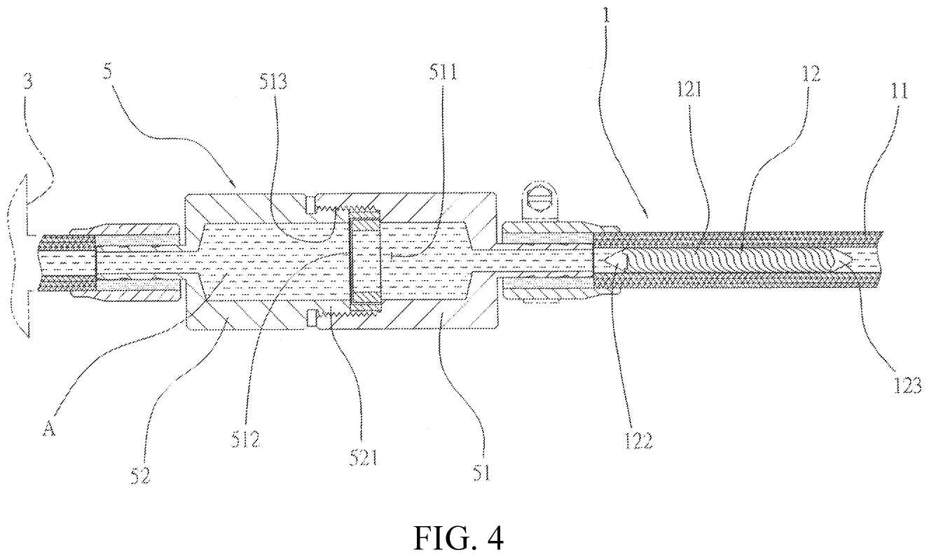

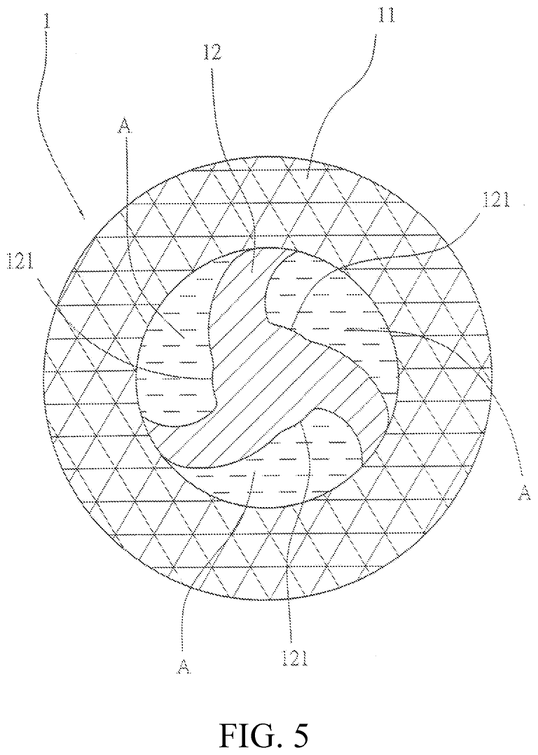

Along the circumference of the spirally threaded shaft 12, the spiral threads 121 includes at least three threads as shown in FIGS. 4 and 5. The three threads speed up, rotate, and disturb the fuel A as the fuel A flows through to reduce its surface tension and density.

In addition, both ends of spirally threaded shaft 12 respectively have cone-shaped first tip 122 and second tip 123, as shown in FIGS. 3, 4, and 6.

As describe above, the fuel economizer provides the following advantages:
1. The first piping element 11 itself may function as a fuel pipe and, unlike the conventional fuel economizer, there is no need for additional piping to the internal combustion engine 2. The cone-shaped first and second tips 122 and 133 of the spirally threaded shaft 12 allow the fuel A to pass through with greater smoothness, speed, and flow.
2. The three spiral threads 121 around the spirally threaded shaft 12 speed, rotate, and disrupt the fuel A to reduce its surface tension and density. In the meantime, the fuel A is divided into three high-speed, interacting vortexes so that the large molecules of the fuel A are crumbled into smaller molecules. The fuel A, with reduced surface tension and density and of smaller molecules, may be quickly and uniformly vaporized in the fuel vaporization device 4, thereby contributing the fuel A's complete combustion in the internal combustion engine 2 and the internal combustion engine 2's power efficiency. The higher efficiency from the internal combustion engine 2 then leads to lower consumption to the fuel A. The operational life of the internal combustion engine 2 and its auxiliary devices may be as such prolonged as well, as shown in FIGS. 2 to 6 (the large and small molecules are not shown).

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A fuel economizer series-connected between a fuel tank and a fuel vaporization device of an internal combustion engine, comprising a first piping element and an oil cup, wherein
a first end of the first piping element is connected to the fuel vaporization device, and a second end of the first piping element is connected to the fuel tank through the oil cup;
the oil cup filter the fuel tank's fuel as the fuel flows through the oil cup and the first piping element into the fuel vaporization device;
a spirally threaded shaft is tightly housed inside the first piping element and the spirally threaded shaft's outer circumference is configured with a plurality of spiral threads to speed, rotate, and disturb the fuel as the fuel flows through to disrupt the surface tension and density of the fuel.

2. The fuel economizer according to claim 1, wherein the oil cup comprises a second piping element, a third piping element, and a filter; both ends of the second piping element respectively connects the first piping element and the third piping element; both ends of the third piping element respectively connects the second piping element and the fuel tank; the second piping element has a filter chamber inside for housing the filter for filtering the fuel as it flows through; a first threaded section is configured along an inner wall of the filter chamber around a front end of the filter chamber; a second threaded section is configured around a circumference of a back end of the third piping element; and the second threaded section is detachably coupled to the first threaded section, thereby limiting the filter.

3. The fuel economizer according to claim 1, wherein the spiral threads comprised three threads for speeding, rotating, disrupting, and reducing surface tension and density of the fuel.

4. The fuel economizer according to claim 2, wherein the spiral threads comprised three threads for speeding, rotating, disrupting, and reducing surface tension and density of the fuel.

5. The fuel economizer according to claim 1, wherein the spirally threaded shaft has cone-shaped first and second tips respectively at both ends of the spirally threaded shaft.

6. The fuel economizer according to claim 2, wherein the spirally threaded shaft has cone-shaped first and second tips respectively at both ends of the spirally threaded shaft.
